(19) United States
(12) Patent Application Publication
(10) Pub. No.: US 2019/0236211 A1
(43) Pub. Date: Aug. 1, 2019

(54) METHOD FOR DYNAMIC MONITORING OF ORGANIZATION CONTENT AND PROACTIVE SUGGESTION OF CHANGES FOR EFFECTIVE SEARCH ENGINE OPTIMIZATION

(71) Applicant: Dell Products L. P., Round Rock, TX (US)

(72) Inventors: Chitrak Gupta, Bangalore (IN); Mainak Roy, Kolkata (IN)

(21) Appl. No.: 15/884,508

(22) Filed: Jan. 31, 2018

(51) Int. Cl. G06F 17/30

(52) U.S. Cl. CPC G06F 17/30864; G06F 17/30684; G06F 17/30011

(57) ABSTRACT

Disclosed is an apparatus and method for dynamic monitoring of organization content and proactive suggestion of changes for effective search engine optimization. In one embodiment of the method, a metadata key phrase of a target electronic document is selected. A search is initiated for electronic documents on the Internet using the selected metadata key phrase. Metadata key phrases are captured from the electronic documents identified by the search. Thereafter the selected metadata key phrase is updated based on the captured metadata key phrases.

### BACKGROUND OF THE INVENTION

An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems can occur via networks that are wired, wireless, or some combination.

### SUMMARY OF THE INVENTION

Disclosed is an apparatus and method for dynamic monitoring of organization content and proactive suggestion of changes for effective search engine optimization. In one embodiment of the method, a metadata key phrase of a target electronic document is selected. A search is initiated for electronic documents on the Internet using the selected metadata key phrase. Metadata key phrases are captured from the electronic documents identified by the search. Thereafter the selected metadata key phrase is updated based on the captured metadata key phrases.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is simplified block diagram of a system employing an exemplary embodiment of the present disclosure;

FIG. 3 shows the system of FIG. 2 with an SEO simulator added thereto;

FIG. 4 is a block diagram of a system according to an exemplary embodiment of the present disclosure;

FIG. 5 illustrates an example of the SEO system shown in FIG. 4;

FIG. 6 is a flow chart illustrating relevant components of a method, according to exemplary embodiments of the present disclosure.

The use of the same reference symbols in different drawings indicates similar or identical items.

### DETAILED DESCRIPTION

The following description in combination with the Figures is provided to assist in understanding the technology disclosed herein. The description is focused on specific implementations and embodiments of the technology, and is provided to assist in understanding the technology. This focus should not be interpreted as a limitation on the scope or applicability of the technology.

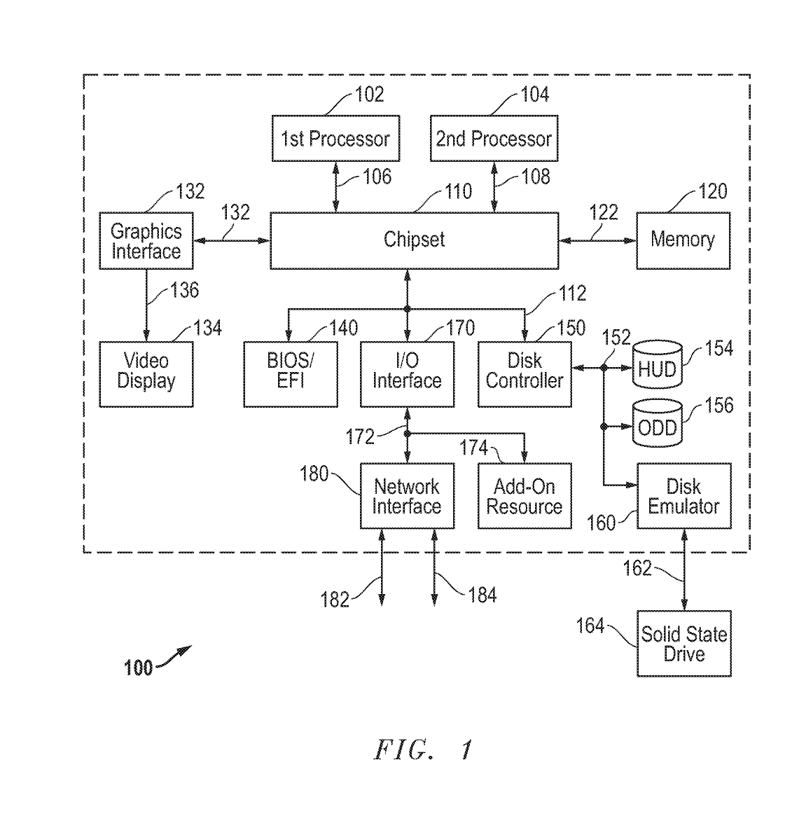

FIG. 1 illustrates an example embodiment of an information handling system 100. For purpose of this disclosure the information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the information handling system 100 can be a personal computer, a laptop computer, a smart phone, a tablet device or other consumer electronic device, a network server, a network storage device, a switch or other network communication device, or any other suitable device and may vary in size, shape, performance, functionality, and price. Further, the information handling system 100 can include processing resources for executing machine-executable code, such as a central processing unit (CPU), a programmable logic array (PLA), an embedded device such as a System-on-a-Chip (SoC), or other control logic hardware. The information handling system 100 can also include one or more computer-readable memories for storing machine-executable code, such as software or data. Additional components of the information handling system 100 can include one or more storage devices that can store machine-executable code, one or more communications ports for communicating with external devices, and various input and output (I/O) devices, such as a keyboard, a mouse, and a video display. The information handling system 100 can also include one or more buses operable to transmit information between the various hardware components.

The information handling system 100 can include devices or modules that embody one or more of the devices or modules described above, and operates to perform one or more of the methods described herein. The information handling system 100 includes one or more processors (such as reference numerals 102 and 104), a chipset 110, a memory 120, a graphics interface 130, a basic input and output system/extensible firmware interface (BIOS/EFI) module 140, a disk controller 150, a disk emulator 160, an input/output (I/O) interface 170, and a network interface 180. Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, the information handling system 100 includes separate memories that are dedicated to each of the processors 102 and 104 via separate memory interfaces. An example of the memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCIExpress (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/EFI module 140 includes BIOS/EFI code operable to detect resources within information handling system 100, to provide drivers for the resources, initialize the resources, and access the resources.

Disk controller 150 includes a disk interface 152 that connects the disk controller 150 to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/O channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within the information handling system 100, on a main circuit board of the information handling system 100, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

Exemplary embodiments may packetize. The information handling system 100 may interface with the communications network (such as a local area network, a wide area network, and/or the Internet 206) via the network interface 180. Messages and data may be packetized into packets of data according to a packet protocol, such as the Internet Protocol. The packets of data contain bits or bytes of data describing the contents, or payload, of a message. A header of each packet of data may contain routing information identifying an origination address and/or a destination address. There are many different known packet protocols, and the Internet Protocol is widely used, so no detailed explanation is needed.

The Internet is a valuable source of information. Consumers use the Internet to find information posted by web sites. This information may be viewed by a user's device (e.g. lap top computer, smart phone, etc.) via a browser. In one embodiment, a web site may refer to a series of web pages or electronic documents that are linked by a site map. For example, the web site www.dell.com (operated by Dell Inc. of Round Rock, Tex.) may include hundreds of pages.

The amount of online information available to consumers is so large that it may be difficult to find relevant information. Search engines available to help with this problem. Consumers may use search engines to locate information, goods, or services of interest on the Internet. A search engine is online service that receives a key phrase, typically as a result of a query, and uses the key phrase to search for web pages relevant thereto. The search engine returns a search engine results page (SERP) that lists the relevant web pages in order of relevancy. Each listing in the SERP typically includes a title and a link to a web page.

The usefulness of a search engine depends on the relevance of the SERP it generates and shows to the user. While there may be many pages that include a particular key phrase or portions thereof, some pages may be more relevant, popular, or authoritative than others. Generally, the listing of pages of the SERP is ordered by relevance with the most relevant pages appearing first.

When a visitor, also referred to as a “user”, clicks on a SERP listing, his/her browser is directed to a corresponding page. The rate or percentage of time that a user clicks on a specific listing when presented with a SERP that includes the listing is referred to as a click through rate (CTR). Data published by companies that provide search engines shows that with few exceptions CTR improves as the position of a listing improves within a SERP. Thus, the highest position listings on the SERP have the highest CTR and the lowest positions have the lowest CTR.

Search engine optimization SEO refers to actions by developers to improve web page listing position in SERPs. SEO best practices recommend optimization of page metadata, which include HTML elements that describe and summarize the contents of a page for the benefit of search engines. Descriptive metadata includes elements such as title, abstract, and key phrases. Selecting key phrases is very important for successful SEO. The disclosure below relates to an automatic optimization of key phrases to be mapped to a web page. When implemented, the optimized key phrases improve the web page relative to ranking factors that are taken into account by search engines when computing the rank of a web page within a SERP.

SEO strategies are typically driven by content and business. Thus, the design of key phrases for web pages varies across product lines. For software products, the phrases can be action oriented where as for hardware the phrases are mostly driven by product components and models. Once implemented, companies should periodically monitor the effectiveness of the SEO results. The success criteria can vary based on the importance of the business; a tier 1 business will get obvious precedence over a tier 3 business. Often, the SEO measurement varies from search engine to search engine. Guidance for search engines can differ; often the algorithm changes. An adaptable system is needed to analyze periodic data by checking the information availability. An advanced system is needed to define the next set of SEO rules and proactive guidance as the information evolves.

SEO is an expensive and time consuming manual process. Companies spend thousands of dollars in SEO to improve the listing of their web pages by search engines. In the past SEO was performed manually in whole or in part by web developers. The manual effort is huge and time consuming, and the result varies if key phrase metadata design is not done based on business requirements.

An individual web developer's experience is critical in successful SEO. Based on experience and available content, web developers try to determine the most impactful key phrases to include in their web page metadata. In the manual process, however, errors are numerous. Sometimes, due to lack of web development experience or knowledge of the business key phrase selection is very generic or misleading. Hence SEO using prior methods is not always impactful, and the effort goes in vain.

Once key phrases are selected, web developers manually add details to the metadata for their web pages and distribute the information. Due to tool limitations and rushed efforts to update a web page, web developers often miss the opportunity to add critical key phrases. Discovering these omissions takes time.

Once the information is published in a web page, web developers spend substantial time periodically measuring the effectiveness of their work. However, using the same system (browser cache) may not showcase the correct result. Also, it is very time consuming and monotonous job for individuals, which raises the possibility of data misinterpretation due to unavoidable fatigue.

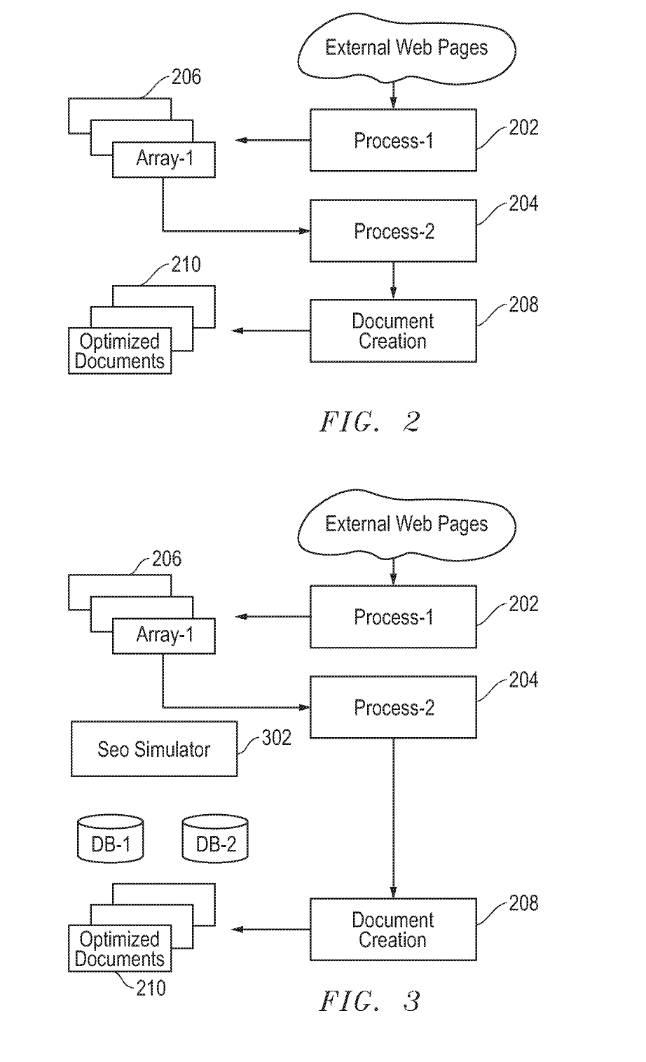

The current SEO methods are manual and are not automated based on an analytics platform. There is no consolidated tool that can perform an end to end SEO. FIG. 2 shows a general SEO system that includes a two-way system to monitor, measure and suggest dynamic changes to improve the visibility of web pages to search engines. A first process 202 works to continually gather information and key phrases from the external world (i.e., from web pages that contain content for the same technology/product line of the target web page or web page sought to be optimized). Process 202 analyzes the way that information is consumed by the users. Key phrases from highly relevant external web pages are captured. A second process 204 uses the information of the first process 202. Process 204 continuously suggests superior and relevant key phrases when a web page is being designed or updated.

With continuing reference to FIG. 2, FIG. 3 shows an additional SEO simulator 302 that can be employed between processes 202 and 204. The primary function of simulator 302 is to process externally gathered information that is stored in data array 206, and perform an analysis based on the present content of the page or pages to be optimized. The content of each element (e.g., Array-1) may vary periodically for a specific product or business. The shift may impact the result. That implies that information is continuously evolving, and accordingly SEO simulator 302 should work continuously to capture minute deviations. Two databases DB-1 (consisting of updated data) and DB-2 (consisting of business driven legacy data) can be employed. SEO simulator 302 should have a preference understanding of the key phrases. Predefined key phrases can appear via this simulator. Based on a usage pattern and a strategy mapping, simulator 302 can be used in the process to supply the best suitable key phrase while the information is being constructed. For the existing content simulator 302 can continue to propose a list of updated key phrases by evaluating the document offline.

SEO simulator 302 can allow a developer to update the local database (DB-2) at any point of time based on changes to business requirements. SEO simulator 302 can also update the database (DB-2) based on the Array-1 results, and capture the dynamic changes based on the user pattern for the same product line. SEO simulator 302 can calibrate data offline once the information is static and DB-1 has been updated with the data based on different streams, which means it's stored in a repository. SEO Simulator 302 can run on a set of documents for a specific business and can suggest global changes based on the business. SEO simulator 302 can allow online calibration, during the time when the data is being constructed using different authoring tools. The interaction can be seamless and does not depend on the platform/tool. Preferred metadata can be in a standard set, which acts as hook while information is placed on web.

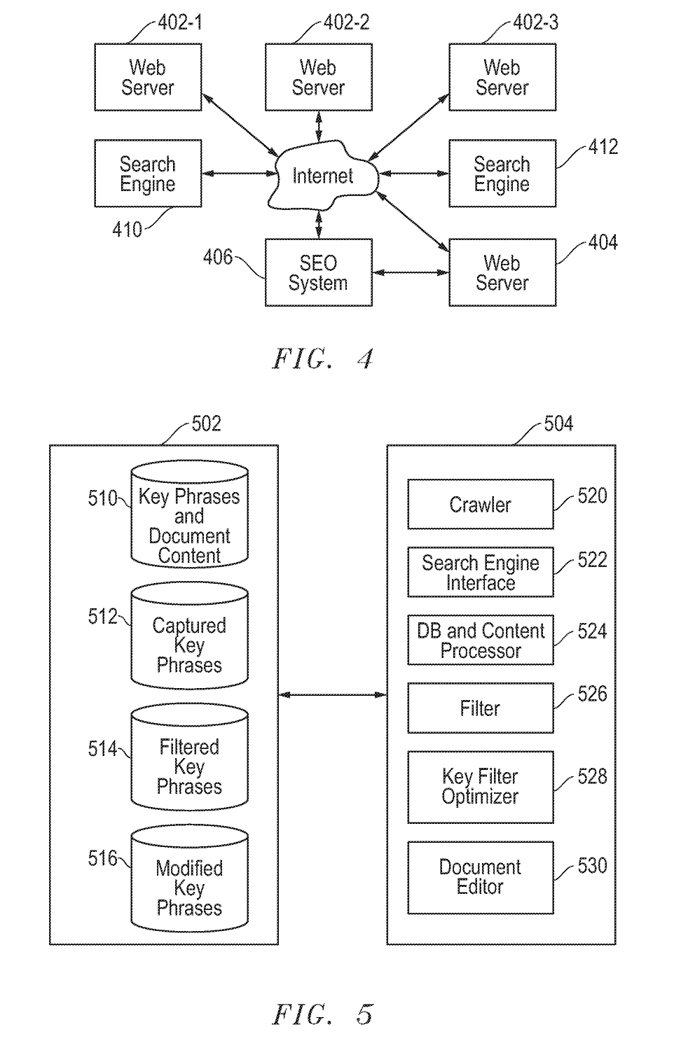

FIG. 4 is a simple block diagram of a system in which one embodiment of the present invention can be employed. As shown in FIG. 4, web servers 402 and 404 are connected to each other via the Internet. For purposes of explanation, each of the web servers 402 and 404 publish pages with similar content. For example, each of the web servers 402 and 404 can publish pages with information regarding enterprise servers for sale by respective companies. FIG. 4 also includes a pair of search engines 410 and 412 coupled to the web servers 402 and 404 via the Internet. Lastly, FIG. 4 shows an SEO system 406. As will be more fully described below, SEO system 406 functions to optimize web pages published by web server 404 by automatically updating metadata thereof. Optimization of metadata, including metadata key phrases of pages published by a web server 404, will result in increased traffic work revenue for the company selling products related to the pages published by web server 404.

FIG. 5 illustrates one embodiment of SEO system 406. As shown in FIG. 5, SEO system 406 includes a data storage system 502 that includes several databases 510-516. FIG. 5 also shows an information handling system 504 that includes several software modules 510-530. For the purpose of explanation, a software module takes form in instructions executing on one or more processors of the information handling system 504. The software modules 510-530 are capable of accessing and processing data of databases 510-516 as will be more fully described below.

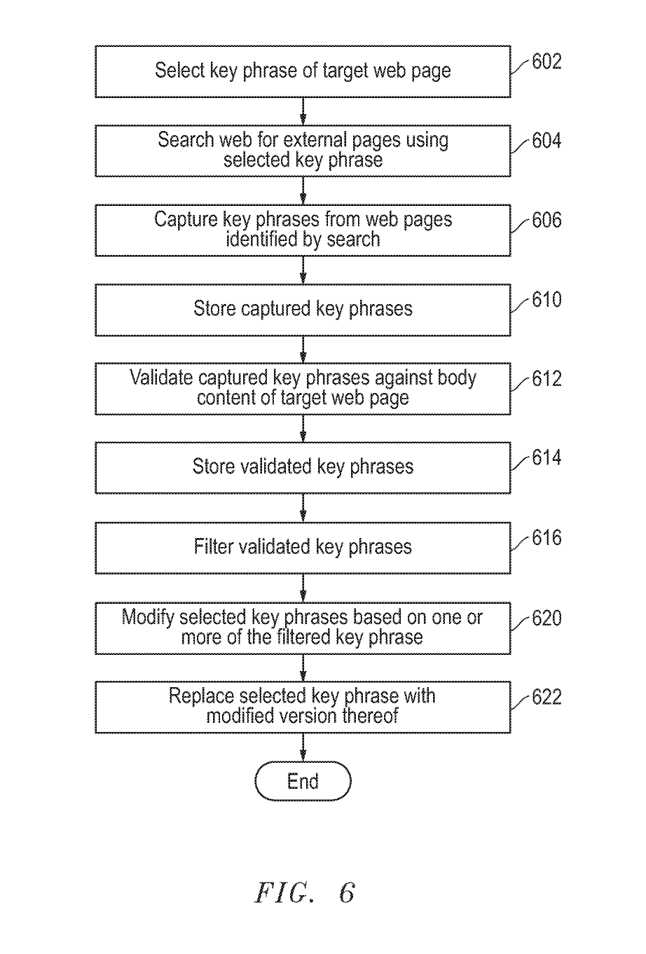

FIG. 6 is a flow chart illustrating relevant aspects of a method for optimizing key phrase of a web page in accordance with an example embodiment of the present invention. With continuing reference to FIGS. 4 and 5 the method shown in FIG. 6 optimizes a key phrase for a web page published by web server 404, based upon one or more synonymous metadata key phrases from web pages of web servers 402, which have similar page content. The method includes automatically updating a web page by replacing a previous key with an optimized key phrase.

Database 510 is accessed to select a key phrase of a target web page as shown in step 602. Database 510 contains metadata key phrases, content and other information for web pages published by web server 404. A target web page is a web page published by server 404 that is sought to be optimized. Search engine interface 522 initiates one or more a web searches using the selected key phrase. In the example embodiment, search interface queries search engines 410 and 412 using the selected key phrase. It is noted that search engines 410 and 412 implement distinct search engine algorithms. More particularly, the algorithms employed by search engines 410 and 412 are distinct such that they can return different search results based upon the same search query. Results from each of the search engines 410-412 are returned to the search engine interface 522. These results include a listing of pages that are relevant to the selected key phrase. The identities or links of the top listings of the search results are provided to crawler 520. In one embodiment, the top 5 listings of each search result is provided to crawler 520. A crawler captures key phrases from the top external web pages of the list. A crawler is a type of bot, or a software program that visits web sites, reads their pages and captures information such as metadata key phrases to create entries for a search engine index, which facilitate faster searches. All the main search engines (e.g., Google, Bing, Yahoo, etc.) use crawlers to build and revise their indexes.

Crawler 520 accesses web pages identified in the search results and captures key phrases thereof. These captured key phrases, along with the search engine rankings of the pages from which they were extracted, are stored within captured key phrase database 512 as shown in step 606. The captured key phrases should be synonyms to the key phrase selected in step 602. Some of the captured key phrases, however, may not be synonymous. DB and content processor 524 can sort out the non-synonymous key phrases in database 512. In one embodiment, DB and content processor 524 sorts the captured key phrases by determining if they are valid. In one embodiment DB and content processor 524 determines key phrase validity by comparing the key phrase against the body content of the target web page. To this end, DB processor can access database 510 to read content for the corresponding target page to be optimized. Incorporated herein by reference in its entirety is U.S. patent application Ser. No. 15/470,300 (Attorney Docket Number DC-107772) filed Mar. 27, 2018 and entitled Validating And Correlating Content, which describes an example method of validating key phrases against body content of an electronic document. The validation process ensures that the key phrases are relevant to the content of the target web page. If the key phrase is not relevant, it is removed from the pool of captured key phrases to be considered for optimizing the selected key phrase.

Filter 526 filters the key phrases contained within database 512 after they are validated. The filtering process removes user defined content such as pronouns, articles, and company specific jargon from the captured key phrases. The filtered key phrases are stored within database 514.

Key phrase optimizer 528 modifies the selected key phrase based upon one or more of the filtered key phrases stored within database 514. The modification may include replacing the selected key phrase in its entirety with one of the filtered key phrases in database 514. Or the modification may include adding one or more words from one of the filtered key phrases to the selected key phrase. Or the modification may include replacing one or more words of the selected key phrase with one or more words from a filtered key phrase. Or the modification may include deleting one or more of the key words in the selected key phrase based on a lack of the words in a filtered key phrase. Or the modification to the selected key phrase in step 620 may be a combination of two or more of the foregoing.

The modified key phrase is stored within database 516 for subsequent processing. More particularly, the modified key phrase should be validated to ensure that it is relevant to the content of the target web page. U.S. patent application entitled Validating And Correlating Content, which is mentioned above, describes the process that can be implemented by DB and content processor 524 for validating modified key phrases. Document editor 530 in step 622 can automatically update the metadata of the target web page by replacing the selected key phrase with the modified version created in step 620. Once replaced, the process shown in FIG. 6 can be repeated by selecting the next key phrase of the target page, or selecting the key phrase of the next target page.

Once web pages on server 404 are optimized in accordance with the process above, the web pages should be monitored to confirm success or to accommodate subsequent changes in the search algorithms used by search engines 410 and 412, that lead to changes in the relevance of web pages in SERPs for a given key phrase query.

As noted, at least one of the filtered key phrases is used in step 620 to modify the selected key phrase. Optimizer 528 functions to select the filtered key phrase from among the many filtered key phrases stored in database 514, which is to be used in the modification of the selected key phrase in step 620. Optimizer 528 may select the filtered key phrase based on any one or one or more factors. For example, optimizer 528 may select the filtered key phrase based on the relevance of the external web page from which it was captured by crawler 520 in step 606. The relevance of a web page is based in part on the position it occupies in a SERP; web pages listed higher in the SERP are more relevant. In addition, optimizer 528 may employ the correlation process described in Validating And Correlating Content, which is mentioned above. More particularly, this patent application describes a process for calculating quotient matrices and correlation constants for key phrases based on the number of words in the key phrases and/or the number of the words in the target page. The quotient matrices and correlation constants can be used to rank the filtered key phrases in database 514. The filtered key phrase with the highest rank may be selected for use in modifying the selected key phrase in step 620. Document editor 530 can automatically update the metadata of the target web page by replacing the selected key phrase with tis modified version thereof

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
selecting a metadata key phrase of a target electronic document;
initiating a search for electronic documents on the Internet using the selected metadata key phrase;
capturing metadata key phrases from the electronic documents identified by the search;
updating the selected metadata key phrase based on the captured metadata key phrases.

2. The method of claim 1 wherein updating the selected metadata key phrase comprises replacing the selecting metadata key phrase with one of the captured metadata key phrase.

3. The method of claim 1 wherein updating the selected metadata key phrase comprises adding a word of one of the captured metadata key phrases to the selected metadata key phrase.

4. The method of claim 1 wherein updating the selected metadata key phrase comprises removing a word of the selected metadata key phrase.

5. The method of claim 1 further comprising an act of publishing the target electronic document after the selected metadata key phrase has been updated.

6. The method of claim 1 further comprising an act of calculating a value for each of the captured metadata key phrases, wherein each value is calculated based on a number of words of a respectively captured metadata key phrase that are contained in a content body of the targeted electronic document.

7. The method of claim 6 further comprising an act of selecting a captured metadata key phrase that corresponds to the calculated value that is highest among the calculated values.

8. The method of claim 7 wherein the selected metadata key phrase is updated based on the selected, captured metadata key phrase that corresponds to the calculated value that is highest among the calculated values.

9. An apparatus comprising:
a central processing unit (CPU);
a memory device storing instructions that are executable by the CPU, wherein a method is implemented in response to the CPU executing the instructions, the method comprising:
selecting a metadata key phrase of a target electronic document;
initiating a search for electronic documents on the Internet using the selected metadata key phrase;
capturing metadata key phrases from the electronic documents identified by the search;
updating the selected metadata key phrase based on the captured metadata key phrases.

10. The apparatus of claim 9 wherein the updating the selected metadata key phrase comprises replacing the selecting metadata key phrase with one of the captured metadata key phrase.

11. The apparatus of claim 9 wherein the updating the selected metadata key phrase comprises adding a word of one of the captured metadata key phrases to the selected metadata key phrase.

12. The apparatus of claim 9 wherein the updating the selected metadata key phrase comprises removing a word of the selected metadata key phrase.

13. The apparatus of claim 9 wherein the method further comprises an act of publishing the target electronic document after the selected metadata key phrase has been updated.

14. The apparatus of claim 9 wherein the method further comprises an act of calculating a value for each of the captured metadata key phrases, wherein each value is calculated based on a number of words of a respectively captured metadata key phrase that are contained in a content body of the targeted electronic document.

15. The method of claim 14 further comprising an act of selecting a captured metadata key phrase that corresponds to the calculated value that is highest among the calculated values.

16. The apparatus of claim 15 wherein the selected metadata key phrase is updated based on the selected, captured metadata key phrase that corresponds to the calculated value that is highest among the calculated values.

17. A computer readable memory (CRM) device storing instructions executable by a central processing unit (CPU), wherein a method is implemented in response to the CPU executing the instructions, the method comprising:
selecting a metadata key phrase of a target electronic document;
initiating a search for electronic documents on the Internet using the selected metadata key phrase;
capturing metadata key phrases from the electronic documents identified by the search;
updating the selected metadata key phrase based on the captured metadata key phrases.

18. The CRM of claim 17 wherein the updating the selected metadata key phrase comprises replacing the selecting metadata key phrase with one of the captured metadata key phrase.

19. The CRM of claim 17 wherein the updating the selected metadata key phrase comprises adding a word of one of the captured metadata key phrases to the selected metadata key phrase.

20. The CRM of claim 17 wherein the method further comprises:
an act of calculating a value for each of the captured metadata key phrases, wherein each value is calculated based on a number of words of a respectively captured metadata key phrase that are contained in a content body of the targeted electronic document;
selecting a captured metadata key phrase that corresponds to the calculated value that is highest among the calculated values;
wherein the selected metadata key phrase is updated based on the selected, captured metadata key phrase that corresponds to the calculated value that is highest among the calculated values.
